(19) United States
(12) Patent Application Publication
(10) Pub. No.: US 2007/0005775 A1
(43) Pub. Date: Jan. 4, 2007

(54) Peer device data transfer

(75) Inventor: Mark E. Philips, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: MOD Systems

(21) Appl. No.: 11/321,264

(22) Filed: Dec. 29, 2005

Related U.S. Application Data
(60) Provisional application No. 60/695,765, filed on Jun. 30, 2005.

(51) Int. Cl. G06F 15/16

(52) U.S. Cl. 709/227

(57) ABSTRACT

A method of operation in connection with a digital device is disclosed. The method of operation includes facilitating a first digital device in establishing a peer-to-peer communication session with a second digital device, with the first and second digital devices being associated with a first file service and a second file service, respectively. The method additionally includes facilitating the first digital device in exchanging information with the second digital device to enable a file accessible by the second digital device be known to the first digital device. The method further includes a copy of the file being subsequently transferred to either the first digital device or a third digital device associated with the first digital device, with a manner of the subsequent transfer being based at least in part on infrastructure connectivity states of the first and second digital devices at a time when the facilitating of the exchange of information is performed. Embodiments of the present invention include but are not limited to devices, subsystems, and systems equipped to operate in the above described manner.

### RELATED APPLICATION

This application is the non-provisional application of provisional application No. 60/695,765, filed on Jun. 30, 2005, claims priority to said 60/695,765 provisional application, which specification is hereby fully incorporated by reference.

### FIELD

Disclosed embodiments of the present invention relate generally to digital devices, and more particularly to data transfer in connection with digital devices.

### BACKGROUND

Digital devices may be used in many different contexts and for a wide variety of applications. Digital devices may be configured in a wide variety of ways, and may include a number of capabilities, including wireless and/or wired capabilities. Digital devices may contain content in a variety of forms, and/or have access to content in a variety of ways.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates some aspects of digital device data transfer, in accordance with various embodiments of this invention;

FIG. 2 illustrates some aspects of digital device data transfer, in accordance with various embodiments of this invention; and

FIG. 3 is a block diagram illustrating some of the functional blocks of a digital device, in accordance with various embodiments of this invention.

### DETAILED DESCRIPTION OF ILLUSTRATIVE EMBODIMENTS

Embodiments of the present invention include but are not limited to a method of operation in connection with a digital device. The method of operation includes facilitating a first digital device in establishing a peer-to-peer communication session with a second digital device, with the first and second digital devices being associated with a first file service and a second file service, respectively. The method additionally includes facilitating the first digital device in exchanging information with the second digital device to enable a file accessible by the second digital device be known to the first digital device. The method further includes a copy of the file being subsequently transferred to either the first digital device or a third digital device associated with the first digital device, with a manner of the subsequent transfer being based at least in part on infrastructure connectivity states of the first and second digital devices at a time when the facilitating of the exchange of information is performed. Embodiments of the present invention include but are not limited to devices, subsystems, and systems equipped to operate in the above-described manner.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

In providing some clarifying context to language which may be used in connection with various embodiments, the phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).” The phrase “(A) B” means “(B) or (A B)”, that is, A is optional.

The phrase “in some embodiments” is used repeatedly. The phrase generally does not refer to the same group of embodiments, however, it may. The phrase “in various embodiments” is used repeatedly. The phrase generally does not refer to the same group of embodiments, however, it may. The terms “comprising,” “having” and “including” are synonymous, unless the context dictates otherwise.

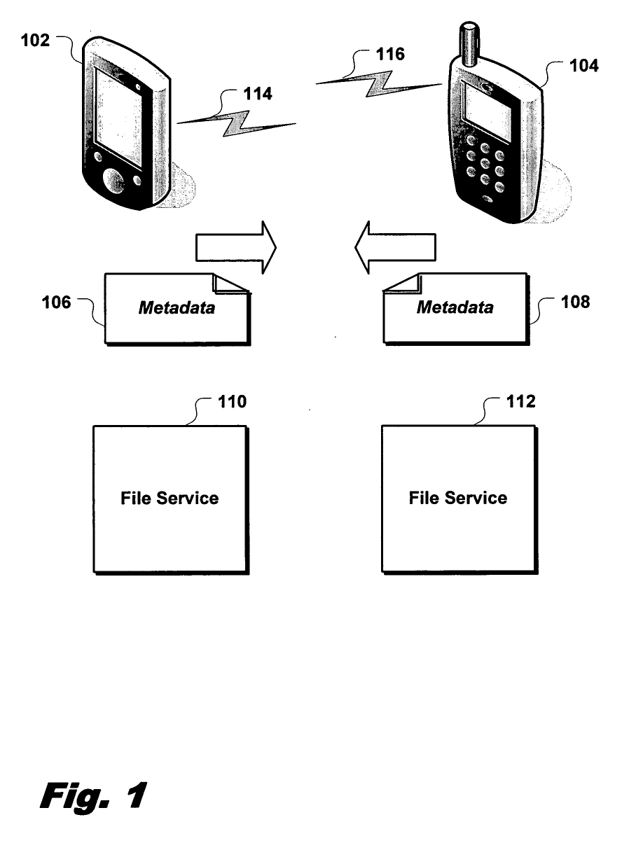

FIG. 1 illustrates some aspects of digital device data transfer, in accordance with various embodiments of this invention. In various embodiments, first digital device 102 may be facilitated in establishing a peer-to-peer communication session with second digital device 104. First and second digital devices 102 and 104 may comprise a wide variety of digital devices, including a portable music player, a cellular phone, a handheld computer, etc. (the graphics used in FIG. I are provided for illustrative purposes only). First and second digital devices 102 and 104 may comprise different types of digital devices (as illustrated in FIG. 1) or the same type of digital device. First digital device 102 may be associated with first file service 110. Second digital device 104 may be associated with second file service 112.

In various embodiments, first digital device 102 may be facilitated in exchanging information with second digital device 104, with the exchange of information enabling a file accessible by second digital device 104 to be known to first digital device 102. In some embodiments, the information may comprise metadata of media content. In some embodiments, metadata may be transmitted by both devices, as illustrated in FIG. 1 with Metadata 106 being transmitted from first digital device 102 and Metadata 108 being transmitted from second digital device 104. Metadata 106 and 108 may include various types of information, including: play list, play count, artist, genre, album, and so forth. In various embodiments, metadata files may include various other types of information. In some embodiments, the metadata may comprise digital rights management data and/or instructions associated with managing the digital rights of the media content. In some embodiments, the information may not be classified as metadata. A copy of the file may be subsequently transferred to either first digital device 102 or a third digital device (not shown) associated with first digital device 102. In various embodiments, a manner of the subsequent transfer may be based at least in part on infrastructure connectivity states of first digital device 102 and second digital device 104 at a time when the facilitating of the exchange of information is performed. In various embodiments, infrastructure connectivity of a device may comprise the device having connectivity to a network which allows access to the device's respective file service directly or indirectly through one or more other devices (not shown), including networking and/or proxy devices. In various embodiments, infrastructure connectivity may comprise connectivity to the Internet. In various embodiments, infrastructure connectivity may be achieved via a wireless link, a wired link, a combination of both wired and wireless links, and so forth.

In various embodiments, the facilitating of first digital device 102 in exchanging information with second digital device 104 may be performed while either first digital device 102 has infrastructure connectivity to first file service 110, second digital device 104 has infrastructure connectivity to second file service 112, or both first digital device 102 and second digital device 104 have infrastructure connectivity to first file service 110 and second file service 112, respectively. In various embodiments, the copy of the file may be subsequently transferred with the copy of the file's continued usability not being subject to subsequent reporting of the transfer by at least one of first digital device 102 and second digital device 104.

In various embodiments, the facilitating of first digital device 102 in exchanging information with second digital device 104 may be performed while first digital device 102 has infrastructure connectivity to first file service 110. In various embodiments, first digital device 102 may be facilitated in reporting the enabling of the transfer or the subsequent transfer to first file service 110.

In various embodiments, first digital device 102 may be facilitated in reporting the enabling of the transfer or the subsequent transfer to second file service 112. In various embodiments, first digital device 102 may be facilitated in exchanging information with second digital device 104 while neither first digital device 102 has infrastructure connectivity to first file service 110, nor second digital device 104 has infrastructure connectivity to second file service 112. In various embodiments, the copy of the file may be subsequently transferred with the copy of the file's continued usability being subject to subsequent reporting of the transfer by at least one of first digital device 102 and second digital device 104.

In various embodiments, information associated with the enabling of the transfer or the subsequent transfer may be stored for subsequent reporting to at least one of first file service 110 and second file service 112 when first digital device 102 has infrastructure connectivity to at least one of first file service 110 and second file service 112, and neither the enabling of the transfer nor the subsequent transfer have been reported to first file service 110 and second file service 112.

In various embodiments, first digital device 102 may be facilitated to report to at least one of first file service 110 and second file service 112, when first digital device 102 subsequently has infrastructure connectivity to at least one of first file service 110 and second file service 112, and neither the enabling of the transfer nor the subsequent transfer have been reported to first file service 110 and second file service 112.

In various embodiments, first file service 110 may be an a-la-carte file service and first digital device 102 may be facilitated in interacting with the a-la-carte file service to pay for the enabling of the transfer or the subsequent transfer.

In various embodiments, first file service 110 may be either a subscription file service or an a-la-carte file service, and first digital device 102 may facilitate in interacting with first file service 110 to enable first file service 110 to facilitate compensation of second file service 112 for the enabling of the transfer or the subsequent transfer. In various embodiments, first file service 110, second file service 112, or any file service discussed in this disclosure, may comprise any type of file service, including an a-la-carte service, a subscription service, a hybrid service of the two, etc.

While FIG. 1 illustrates digital devices 102 and 104, other embodiments may include a different number of such digital devices. Digital devices 102 and 104 may communicate with each other via signals 114 and 116, respectively. Signals 114 and 116 may utilize one or more of a number of available channels. A channel in a communications medium may be defined in any number of ways, including a frequency band, a time period, a coding scheme (for example, in embodiments making use of spread spectrum techniques), a combination of spatial and other information, and the like, including multiple combinations of differentiating a communications medium. Channels are defined in various ways for particular communications protocols, and various embodiments may make use of various communications protocols. In various embodiments, digital devices 102 and 104 may communicate with each other in a different manner, such as, for example, via a wired link.

In various embodiments, first file service 110 may facilitate receipt of a reporting of an exchange of information between first digital device 102 and second digital device 104 to enable a file accessible to second digital device 104 to be known to first digital device 102, and subsequent transfer to first digital device 102 or a third digital device (not shown) associated with first digital device 102, from a selected one of first digital device 102, second digital device 104, and file service 112 associated with second digital device 104. In various embodiments, file service 110 may facilitate interaction with first digital device 102 to enable first digital device 102 to pay for the enabling of the transfer or the subsequent transfer. In various embodiments, payment may occur at different points in time based upon the modality of the transfer of the media content. In various embodiments, file service 112 associated with second digital device 104 may be facilitated to be compensated for the enabling of the transfer or the subsequent transfer.

In various embodiments, first file service 110 or second file service 112 may include a reporting module adapted to facilitate the applicable file service to receive reporting of an exchange of information between first digital device 102 and second digital device 104 to enable a file accessible by second digital device 104 to be known to first digital device 102, and a copy of the file to be subsequently transferred to either first digital device 102 or a third digital device (not shown) associated with first digital device 102, with a manner of the subsequent transfer being based at least in part on infrastructure connectivity states of first digital device 102 and second digital device 104 at a time when the facilitating of the exchange of information is performed. In various embodiments, first file service 110 or second file service 112 may include a payment module adapted to facilitate payment by a user of first digital device 102 for the enabling of the transfer or the subsequent transfer. In various embodiments, the payment module may be further adapted to facilitate file service 112 associated with second digital device 104 to be compensated for the enabling of the transfer or the subsequent transfer. As described earlier, in various embodiments, payments may occur at different points in time based upon the modality of the transfer of the media content.

In various embodiments, first file service 110 or second file service 112 may include a reporting module adapted to facilitate the applicable file service to receive reporting of an exchanging of information between first digital device 102 and second digital device 104 to enable a file accessible by first digital device 102 to be known to second digital device 104, and a copy of the file to be subsequently transferred to either second digital device 104 or a third digital device (not shown) associated with second digital device 104, with a manner of the subsequent transfer being based at least in part on infrastructure connectivity states of first digital device 102 and second digital device 104 at a time when the facilitating of the exchange of information is performed. In various embodiments, the applicable file service may include a payment module adapted to facilitate interaction with file service 112 associated with second digital device 104 to facilitate receipt of compensation for the enabling of the transfer or the subsequent transfer. As described earlier, in various embodiments, payments may occur at different points in time based upon the modality of the transfer of the media content.

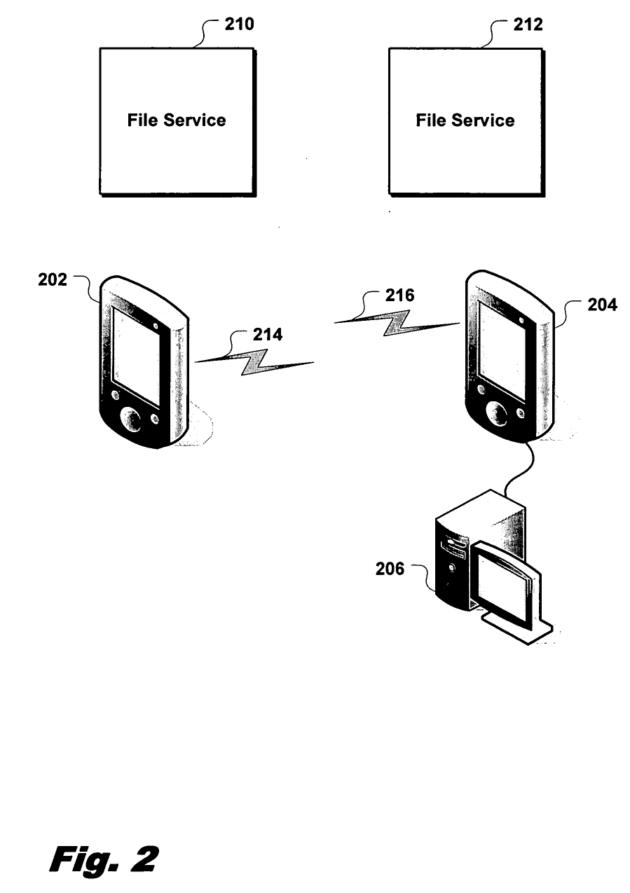

FIG. 2 illustrates some aspects of digital device data transfer, in accordance with various embodiments of this invention. In various embodiments, first digital device 202 may be facilitated in establishing a peer-to-peer communication session with second digital device 204. First and second digital devices 202 and 204 may comprise a wide variety of digital devices, including a portable music player, a cellular phone, a handheld computer, etc. (the graphics used in FIG. 2 are provided for illustrative purposes only). First and second digital devices 202 and 204 may comprise different types of digital devices or the same type of digital device (as illustrated in FIG. 2). First digital device 202 may be associated with first file service 210. Second digital device 204 may be associated with second file service 212.

In various embodiments, first digital device 202 may be facilitated in exchanging information with second digital device 204, with the exchange of information enabling a file accessible by first digital device 202 to be known to second digital device 204. In some embodiments, the information may comprise metadata, such as the metadata described earlier. In some embodiments, the information may not be classified as metadata. A copy of the file may be subsequently transferred to either second digital device 204 or third digital device 206 associated with second digital device 204. In various embodiments, a manner of the subsequent transfer may be based at least in part on infrastructure connectivity states of first digital device 202 and second digital device 204 at a time when the facilitating of the exchange of information is performed. In various embodiments, third digital device 206 may be a computer (as shown in FIG. 2) or another type of digital device.

In various embodiments, the facilitating of first digital device 202 in exchanging information with second digital device 204 may be performed while either first digital device 202 has infrastructure connectivity to first file service 210, second digital device 204 has infrastructure connectivity to second file service 212, or both first digital device 202 and second digital device 204 have infrastructure connectivity to first file service 210 and second file service 212, respectively. As described earlier, the connectivity may direct or indirect, through one or more networking and/or proxy devices. In various embodiments, the copy of the file may be subsequently transferred with the copy of the file's continued usability not being subject to subsequent reporting of the transfer by at least one of first digital device 202 and second digital device 204.

In various embodiments, the facilitating of first digital device 202 in exchanging information with second digital device 204 may be performed while first digital device 202 has infrastructure connectivity to first file service 210. In various embodiments, first digital device 202 may be facilitated in reporting the enabling of the transfer or the subsequent transfer to first file service 210.

In various embodiments, first digital device 202 may be facilitated in reporting the enabling of the transfer or the subsequent transfer to second file service 212. In various embodiments, first digital device 202 may be facilitated in exchanging information with second digital device 204 while neither first digital device 202 has infrastructure connectivity to first file service 210, nor second digital device 204 has infrastructure connectivity to second file service 212. In various embodiments, the copy of the file may be subsequently transferred with the copy of the file's continued usability being subject to subsequent reporting of the transfer by at least one of first digital device 202 and second digital device 204.

In various embodiments, information associated with the enabling of the transfer or the subsequent transfer may be stored for subsequent reporting to at least one of first file service 210 and second file service 212 when first digital device 202 has infrastructure connectivity to at least one of first file service 210 and second file service 212, and neither the enabling of the transfer nor the subsequent transfer have been reported to first file service 210 and second file service 212.

In various embodiments, first digital device 202 may be facilitated to report to at least one of first file service 210 and second file service 212, when first digital device 202 subsequently has infrastructure connectivity to at least one of first file service 210 and second file service 212, and neither the enabling of the transfer nor the subsequent transfer have been reported to first file service 210 and second file service 212.

In various embodiments, first file service 210 may be an a-la-carte file service and first digital device 202 may be facilitated in interacting with the a-la-carte file service to pay for the enabling of the transfer or the subsequent transfer.

In various embodiments, first file service 210 may be either a subscription file service or an a-la-carte file service, and first digital device 202 may facilitate in interacting with first file service 210 to enable first file service 210 to facilitate compensation of second file service 212 for the enabling of the transfer or the subsequent transfer.

While FIG. 2 illustrates digital devices 202 and 204, other embodiments may include a different number of such digital devices. Digital devices 202 and 204 may communicate with each other via signals 214 and 216, respectively. Signals 214 and 216 may utilize one or more of a number of available channels. A channel in a communications medium may be defined in any number of ways, including a frequency band, a time period, a coding scheme (for example, in embodiments making use of spread spectrum techniques), a combination of spatial and other information, and the like, including multiple combinations of differentiating a communications medium. Channels are defined in various ways for particular communications protocols, and various embodiments may make use of various communications protocols. In various embodiments, digital devices 202 and 204 may communicate with each other in a different manner, such as, for example, via a wired link.

In various embodiments, first file service 210 may facilitate receipt of a reporting of an exchange of information between first digital device 202 and second digital device 204 to enable a file accessible to first digital device 202 to be known to second digital device 204, and subsequent transfer to second digital device 204 or third digital device 206 associated with second digital device 204, from a selected one of first digital device 202, second digital device 204, and file service 212 associated with second digital device 204. In various embodiments, interaction with file service 212 may be facilitated to enable receipt of compensation for the enabling of the transfer or the subsequent transfer.

Thus, FIGS. 1 and 2 illustrate various embodiments in which digital devices may form a connection between each other to facilitate content transfer. Content exchange may take place in the context of a variety of networking methods. In various embodiments, media content exchange of any type may be facilitated. In various embodiments, media content exchange in the context of competing services may be facilitated. In various embodiments, content may be transferred directly between digital devices. In various embodiments, content may be transferred from a file service of the respective other device, a third party, and so forth. In various embodiments, functionality to transfer both among devices, and well as other ways (e.g., from a file service of the respective other device), may be supported.

Digital rights management (DRM), in connection with the content and/or transfer of data, may be used in a wide variety of ways. In some embodiments in which content is protected by a DRM system which requires license information for use, the applicable DRM license information will be acquired in order to access the content (e.g., in the case of an audio file, for the file to play), with the applicable protocol being implemented. In various embodiments, when content is not associated with DRM, then the content may be transferred between devices possibly without payment, with or without the use of a file service. In some embodiments, file service content may typically be associated with DRM, whether the service is an a-la-carte service, a subscription service, and so forth. In some embodiments, if content is not acquired through the available file services but does have DRM associated with it, then the transfer may default to trying to make the transaction with the available file service. In various embodiments, the file service may have access to licensing servers. The licensing servers may issue licenses based on device information and the content to be licensed, with the license allowing the content to be played on the device. In some embodiments, the actual license may not be delivered to the device without payment processing. In some embodiments, if one or all of the devices exchanging content are connected to network infrastructure and payment processing happens while they are connected, then the device(s) receiving DRM content may receive their license. In some embodiments, if neither device is connected to infrastructure, then the device(s) receiving DRM content may have to receive a temporary license. In some embodiments, such a temporary license may be issued by the sending device. In some embodiments, this license may have an expiration date, or be restricted by number of plays (e.g., as in a music or video file), and so forth. In some such embodiments, the next time the device is connected to infrastructure and payment is received, the device may receive the permanent license for that content from the actual file service license servers. In various other embodiments, peer device data transfer implementations may differ in the context of DRM. In various embodiments, multiple DRM systems may be supported.

In providing additional context in various embodiments, two digital devices may form a connection by various operations, including one or more of the following: a beacon may be sent out by one digital device, a response may be received, one device may relay a request to be added as a known data exchange device in regard to the other device, a network connection may be established between the two devices, the connection process may open a number of ports among the devices (e.g., two, four) to further transmission and reception, and the like. In various embodiments, different operations may be performed. In various embodiments, more than two digital devices may be involved.

In some embodiments, credentials may be exchanged between multiple devices, including such items as licenses, session IDs, HTTPS information, SSL information, and the like. In various embodiments, different credentials may be involved. In various other embodiments, connections among devices may be facilitated in other ways.

Content exchange may be effectuated in a wide range of ways, in accordance with various embodiments of the invention. In some embodiments, metadata may be exchanged. Metadata files may have different sending/receiving requirements with respect to size, and may include various types of information, including but not limited to: play list, play count, artist, genre, and album information. In some embodiments, metadata files may include various other types of information, including but not limited to digital right management related data and/or instruction.

An exchange between two services may be performed in a number of ways, including one or more of the following operations: a user may select item(s) to be exchanged, the item(s) may be transferred by sending the content to the other device, and reporting and payment in connection with the transfer of content may occur. In various embodiments, a license may be sent along with the content. In some such embodiments, a license may be sent if the content was obtained by the sending device via an a-la-carte service. In some such embodiments, a license may be sent if the content was obtained by the sending device via a subscription service. In various embodiments, an exchange between two services may include one or more different operations.

In various embodiments, reporting and payment may vary depending upon infrastructure connectivity states of the devices. Where at least one device is connected to infrastructure, reporting and payment may take place in various ways, including the device that is connected to infrastructure reporting the file transfer to both services, payment being handled by the service of the receiver (e.g., the receiver may be charged on their account, with a bounty (referral reward) being provided to the service of the sender), and so forth. In some embodiments, payment may be handled by the service of the sender. In some embodiments, license information may also be reported together with the reporting of the file transfer to a service. In some such embodiments, license reporting at the time of the reporting of the file transfer may occur where license information is not transmitted with the content. In various embodiments, the sending service may bill the receiving service for the bounty. In various embodiments, the sending service and receiving service may handle or process a bounty payment, credit, or the like, in a number of ways. In various embodiments where at least one device is connected to infrastructure, reporting and payment may take place in other ways.

Where no device is connected to infrastructure at the time of the content transfer, reporting and payment may take place in various ways. In some such embodiments, both devices may hold files explaining the transaction as a result of the transfer having taken place. In some embodiments, such a file may activate the next time the device on which it resides connects to infrastructure, in accordance with various embodiments of the invention. In some embodiments, the receiving device may have a file with an expiration date that will make the exchanged content invalid after a period of time. In some embodiments, the content file may comprise this file. Monetary charging may be performed in a number of ways, in accordance with various embodiments, including automatic charge by credit card of the applicable end-user. In some embodiments, when a receiving device connects to infrastructure, payment may occur, with the receiver being charged on their account. In some embodiments, a bounty may also be provided to the service of the sender. Content transfer reporting when a device connects to infrastructure may occur in a wide number of ways, and may include reporting of file movement and so forth. In some embodiments, license information may also be reported at this time. In some embodiments, when a sending device connects to infrastructure, the sending device may be notified when the transaction has been reported and completed. In some embodiments, the explanation file may then be deleted. In various embodiments where no device is connected to infrastructure at the time of the content transfer, reporting and payment may take place in other ways.

In various embodiments, an exchange between two subscription services may be facilitated. In various embodiments, an exchange between two a-la-carte services may be facilitated. In various embodiments, an exchange between an a-la-carte service and a subscription service may be facilitated (e.g., an exchange from an a-la-carte service to a subscription service; an exchange from a subscription service to an a-la-carte service). In various embodiments, such exchanges may take place in the context of an exchange involving more than two services, including more than two file services, a third party clearing house, and so forth.

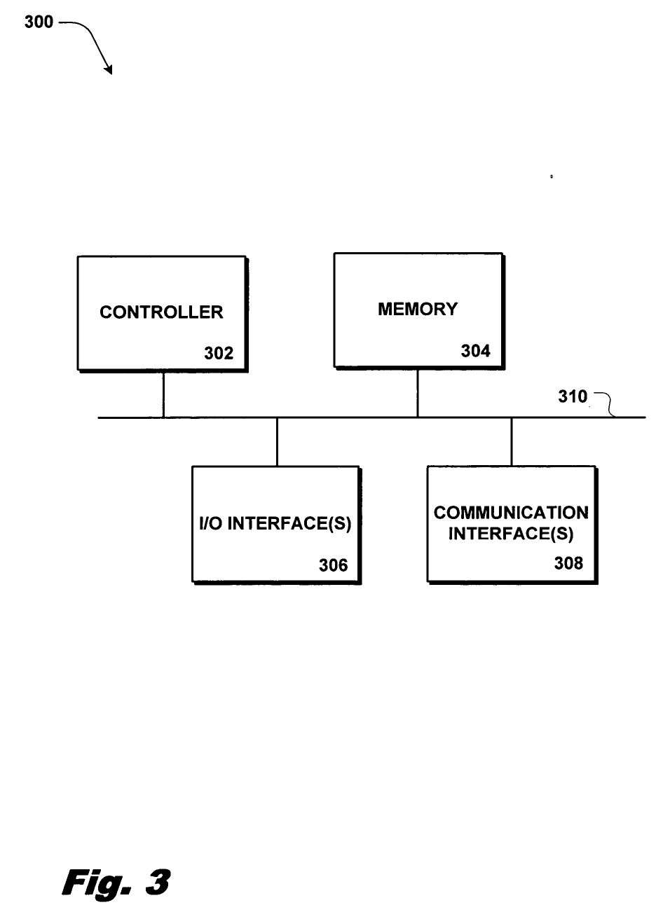

FIG. 3 is a block diagram illustrating some of the functional blocks of digital device 300, in accordance with various embodiments of this invention. As shown, digital device 300 may include controller 302 and may include memory 304. In some embodiments, controller 302 may comprise one or more processing cores. In some embodiments, digital device 300 may include multiple controllers and/or processors. Additionally, in various embodiments, digital device 300 may include other memory (not shown), input/output interface(s) 306 (such as keyboard, cursor control, microphone, speakers, display screen and so forth) and communication interface(s) 308 (such as network interface cards, modems and so forth). The elements may be coupled to each other via system bus 310, which may represent one or more buses. In the case where system bus 310 represents multiple buses, the multiple buses may be bridged by one or more bus bridges (not shown).

In some embodiments, communication interface(s) 308 may be coupled to a medium (not shown) and may facilitate transmission over the medium. In various embodiments, the medium may comprise a wire media, or its equivalent. In various other embodiments, the medium may comprise a wireless medium, such as, but not limited to, radio frequency (RF) or infrared (TR) signals transmitted through air, etc.

These elements each perform their conventional functions known in the art. In various embodiments, communication interface(s) 308 may facilitate coupling of digital device 300 to another digital device (not shown), a network (not shown), and so forth. Memory 304 and/or other memory (not shown) of digital device 300 may be employed to store a copy of programming instructions implementing various aspects of one or more earlier described embodiments of the present invention. In various embodiments, nonvolatile memory may serve to hold one copy of any instructions, with the one copy serving the functions of both a working copy and a permanent copy of the instructions.

In cases where digital device 300 serves in a receiving capacity, memory 304 may include instructions comprising a communication module adapted to establish a peer-to-peer communication session with a first other apparatus (not shown). In cases where digital device 300 serves in a receiving capacity, memory 304 may include instructions comprising an information exchange module adapted to facilitate digital device 300 in exchanging information with the first other apparatus to enable a file accessible by the first other apparatus to be known to digital device 300, and a copy of the file to be subsequently transferred to either digital device 300 or a second other apparatus (not shown) associated with digital device 300, with a manner of the subsequent transfer being based at least in part on infrastructure connectivity states of the digital device 300 and the first other apparatus at a time when the facilitating of the exchange of information is performed. In cases where digital device 300 serves in a receiving capacity, memory 304 may include additional and/or alternative instructions.

In cases where digital device 300 serves in a sending capacity, memory 304 may include instructions comprising a communication module adapted to establish a peer-to-peer communication session with a first other apparatus (not shown). In cases where digital device 300 serves in a sending capacity, memory 304 may include instructions comprising an information exchange module adapted to facilitate digital device 300 in exchanging information with the first other apparatus to enable a file accessible by digital device 300 to be known to the first other apparatus, and a copy of the file to be subsequently transferred to either the first other apparatus or a second other apparatus (not shown) associated with the first other apparatus, with a manner of the subsequent transfer being based at least in part on infrastructure connectivity states of digital device 300 and the first other apparatus at a time when the facilitating of the exchange of information is performed. In cases where digital device 300 serves in a sending capacity, memory 304 may include additional and/or alternative instructions.

The constitution of these elements 302-310 are known, and accordingly will not be further described. In alternate embodiments, part or all of the one or more modules implementing various aspects of the one or more earlier described embodiments of the present invention may be implemented in hardware, for example, using one or more Application Specific Integrated Circuits (ASICs) instead.

Thus, it can be seen from the above description, a method of operation in connection with a digital device is described. The method of operation includes facilitating a first digital device in establishing a peer-to-peer communication session with a second digital device, with the first and second digital devices being associated with a first file service and a second file service, respectively. The method additionally includes facilitating the first digital device in exchanging information with the second digital device to enable a file accessible by the second digital device be known to the first digital device. The method further includes a copy of the file being subsequently transferred to either the first digital device or a third digital device associated with the first digital device, with a manner of the subsequent transfer being based at least in part on infrastructure connectivity states of the first and second digital devices at a time when the facilitating of the exchange of information is performed. Communications nodes and devices, subsystems, and systems equipped to operate in the above manner have also been described. While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

What is claimed is:

1. A method, comprising:
facilitating a first digital device in establishing a peer-to-peer communication session with a second digital device, the first and second digital devices being associated with a first and a second file service respectively; and
facilitating the first digital device in exchanging information with the second digital device to enable a file accessible by the second digital device be known to the first digital device, and a copy of the file to be subsequently transferred to either the first digital device or a third digital device associated with the first digital device, with a manner of the subsequent transfer being based at least in part on infrastructure connectivity states of the first and second digital devices at a time when the facilitating of the exchange of information is performed.

2. The method of claim 1, wherein said facilitating of the first digital device in exchanging information with the second digital device is performed while either the first digital device has infrastructure connectivity to the first file service, the second digital device has infrastructure connectivity to the second file service, or both the first and second digital devices have infrastructure connectivity to the first and second file services respectively, and wherein the copy of the file is to be subsequently transferred with the copy of the file's continued usability not being subject to subsequent reporting of the transfer by at least one of the first and second digital devices.

3. The method of claim 2, wherein said facilitating of the first digital device in exchanging information with the second digital device is performed while the first digital device has infrastructure connectivity to the first file service, and the method further comprises facilitating the first digital device in reporting the enabling of the transfer or the subsequent transfer to the first file service.

4. The method of claim 3, wherein the method further comprises facilitating the first digital device in reporting the enabling of the transfer or the subsequent transfer to the second file service.

5. The method of claim 1, wherein said facilitating of the first digital device in exchanging information with the second digital device is performed while neither the first digital device has infrastructure connectivity to the first file service, nor the second digital device has infrastructure connectivity to the second file service, and wherein the copy of the file is to be subsequently transferred with the copy of the file's continued usability being subject to subsequent reporting of the transfer by at least one of the first and second digital devices.

6. The method of claim 5, wherein the method further comprises storing information associated with the enabling of the transfer or the subsequent transfer, for subsequent reporting to at least one of the first and second file services when the first digital device has infrastructure connectivity to the at least one of the first and second file services and neither the enabling of the transfer nor the subsequent transfer have been reported to the first and second file services.

7. The method of 6, wherein the method further comprises facilitating the first digital device to report to at least one of the first and second file services, when the first digital device subsequently has infrastructure connectivity to the at least one of the first and second file services and neither the enabling of the transfer nor the subsequent transfer have been reported to the first and second file services.

8. The method of claim 1, wherein the first file service is an a-la-carte file service and the method further comprises facilitating the first digital device in interacting with the a-la-carte file service to pay for the enabling of the transfer or the subsequent transfer.

9. The method of claim 1, wherein the first file service is a selected one of a subscription file service and an a-la-carte file service, and the method further comprises facilitating the first digital device in interacting with the selected one of the subscription file service and the a-la-carte file service to enable the first file service to facilitate compensation of the second file service for the enabling of the transfer or the subsequent transfer.

10. A method, comprising:
facilitating a first digital device in establishing a peer-to-peer communication session with a second digital device, the first and second digital devices being associated with a first and a second file service respectively; and
facilitating the first digital device in exchanging information with the second digital device to enable a file accessible by the first digital device be known to the second digital device, and a copy of the file to be subsequently transferred to either the second digital device or a third digital device associated with the second digital device, with a manner of the subsequent transfer being based at least in part on infrastructure connectivity states of the first and second digital devices at a time when the facilitating of the exchange of information is performed.

11. The method of claim 10, wherein said facilitating of the first digital device in exchanging information with the second digital device is performed while either the first digital device has infrastructure connectivity to the first file service, the second digital device has infrastructure connectivity to the second file service, or both the first and second digital devices have infrastructure connectivity to the first and second file services respectively, and wherein the copy of the file is to be subsequently transferred with the copy of the file's continued usability not being subject to subsequent reporting of the transfer by at least one of the first and second digital devices.

12. The method of claim 11, wherein said facilitating of the first digital device in exchanging information with the second digital device is performed while the first digital device has infrastructure connectivity to the first file service, and the method further comprises facilitating the first digital device in reporting the enabling of the transfer or the subsequent transfer to the first file service.

13. The method of claim 12, wherein the method further comprises facilitating the first digital device in reporting the enabling of the transfer or the subsequent transfer to the second file service.

14. The method of claim 10, wherein said facilitating of the first digital device in exchanging information with the second digital device is performed while neither the first digital device has infrastructure connectivity to the first file service, nor the second digital device has infrastructure connectivity to the second file service, and wherein the copy of the file is to be subsequently transferred with the copy of the file's continued usability being subject to subsequent reporting of the transfer by at least one of the first and second digital devices.

15. The method of claim 14, wherein the method further comprises storing information associated with the enabling of the transfer or the subsequent transfer, for subsequent reporting to at least one of the first and second file services when the first digital device has infrastructure connectivity to the at least one of the first and second file services and neither the enabling of the transfer nor the subsequent transfer have been reported to the first and second file services.

16. The method of 15, wherein the method further comprises facilitating the first digital device to report to at least one of the first and second file services, when the first digital device subsequently has infrastructure connectivity to the at least one of the first and second file services and neither the enabling of the transfer nor the subsequent transfer have been reported to the first and second file services.

17. A method comprising:
facilitating receipt of a reporting of an exchange of information between a first and a second digital device to enable a file accessible to the second digital device to be known to the first digital device, and subsequent transfer to the first digital device or a third digital device associated with the first digital device, from a selected one of the first digital device, the second digital device, and a file service associated with the second digital device; and
facilitating interaction with the first digital device to enable the first digital device to pay for the enabling of the transfer or the subsequent transfer.

18. The method of claim 17, wherein the method further comprises facilitating the file service associated with the second digital device to be compensated for the enabling of the transfer or the subsequent transfer.

19. A method comprising:
facilitating receipt of a reporting of an exchange of information between a first and a second digital device to enable a file accessible to the first digital device to be known to the second digital device, and subsequent transfer to the second digital device or a third digital device associated with the second digital device, from a selected one of the first digital device, the second digital device, and a file service associated with the second digital device; and
facilitating interaction with the file service to enable receipt of compensation for the enabling of the transfer or the subsequent transfer.

20. An apparatus comprising:
a communication module adapted to establish a peer-to-peer communication session with a first other apparatus; and
an information exchange module adapted to facilitate the apparatus in exchanging information with the first other apparatus to enable a file accessible by the first other apparatus to be known to the apparatus, and a copy of the file to be subsequently transferred to either the apparatus or a second other apparatus associated with the apparatus, with a manner of the subsequent transfer being based at least in part on infrastructure connectivity states of the apparatus and the first other apparatus at a time when the facilitating of the exchange of information is performed.

21. An apparatus comprising:
a communication module adapted to establish a peer-to-peer communication session with a first other apparatus; and
an information exchange module adapted to facilitate the apparatus in exchanging information with the first other apparatus to enable a file accessible by the apparatus to be known to the first other apparatus, and a copy of the file to be subsequently transferred to either the first other apparatus or a second other apparatus associated with the first other apparatus, with a manner of the subsequent transfer being based at least in part on infrastructure connectivity states of the apparatus and the first other apparatus at a time when the facilitating of the exchange of information is performed.

22. An apparatus comprising:
a reporting module adapted to facilitate the apparatus to receive reporting of an exchanging of information between a first and a second digital device to enable a file accessible by the second digital device to be known to the first digital device, and a copy of the file to be subsequently transferred to either the first digital device or a third digital device associated with the first digital device, with a manner of the subsequent transfer being based at least in part on infrastructure connectivity states of the first and second digital devices at a time when the facilitating of the exchange of information is performed; and
a payment module adapted to facilitate payment by a user of the first digital device for the enabling of the transfer or the subsequent transfer.

23. The apparatus of claim 22, wherein the payment module is further adapted to facilitate a file service associated with the second digital device to be compensated for the enabling of the transfer or the subsequent transfer.

24. An apparatus comprising:
a reporting module adapted to facilitate the apparatus to receive reporting of an exchanging of information between a first and a second digital device to enable a file accessible by the first digital device to be known to the second digital device, and a copy of the file to be subsequently transferred to either the second digital device or a third digital device associated with the second digital device, with a manner of the subsequent transfer being based at least in part on infrastructure connectivity states of the first and second digital devices at a time when the facilitating of the exchange of information is performed; and
a payment module adapted to facilitate interaction with a file service associated with the second digital device to facilitate receipt of compensation for the enabling of the transfer or the subsequent transfer.
